(19) United States
(12) Patent Application Publication
(10) Pub. No.: US 2020/0175833 A1
(43) Pub. Date: Jun. 4, 2020

(54) PERSONAL SAFETY RECORDING SYSTEM AND METHOD OF USE

(71) Applicant: John Martin, Midvale, UT (US)

(72) Inventor: John Martin, Midvale, UT (US)

(21) Appl. No.: 16/204,051

(22) Filed: Nov. 29, 2018

(51) Int. Cl. G08B 15/00; G08B 21/02; G08B 5/22; G08B 3/10

(52) U.S. Cl. CPC G08B 15/001; G08B 15/004; G08B 3/1083; G08B 5/223; G08B 21/02

(57) ABSTRACT

A personal safety recording system allows an individual to carry a concealed camera on themselves. The camera being concealed increases the likelihood of capturing any threatening or harmful behavior experienced or witnessed by the individual. The camera could be concealed in an owl or other shape and is intended to appear a normal clothing article. While the camera is recording a trigger or notification sequence alerts a friend or other third party that the camera is capturing an event that requires attention. The recording is sent through a transmitter or through another computing device such as a phone. The person's voice or buttons are examples of how the system could quickly and discreetly be activated to transmit the recording.

### BACKGROUND

### 1. Field of the Invention

The present invention relates to a durable and weatherproof concealed portable security systems for recording audio, video, and location while a person moves from one location to another and if the person sees a threat the device can immediately notify their emergency contacts by either pressing the two buttons on each side or by voice recognition causing the device to transmit the footage through their phone app and data service or the device can include a built-in data plan. Upon notification, their emergency contacts can review the footage and location link to determine the nature of the emergency and immediately take the appropriate steps to help protect the person, including contacting law enforcement and sharing the link with the footage.

### 2. Description of Related Art

Security systems are well known in the art and are effective means to ensure that no damage, harm or other negative effects occur to person or property. For example, FIG. 1 depicts a conventional portable security system 101 having a personal device 103 with a camera 105 therein. During use, if a person 107 becomes aware of a threat 109 the camera 105 is activated and records what it views. This recording is then used to remedy any damages sustained by the threat 109.

One of the problems commonly associated with system 101 is its limited efficiency. For example, the threat 109 generally denies the person 107 and removes the personal device 103, halts its use or destroys it. With no recording, a remedy to any harm is difficult and with no evidence of a crime, a conviction becomes difficult.

Additionally, when the threat 109 is not identified with sufficient time, activation of the camera 105 may not occur further limiting the efficiency of system 101.

Accordingly, although great strides have been made in the area of portable security systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common portable security system;

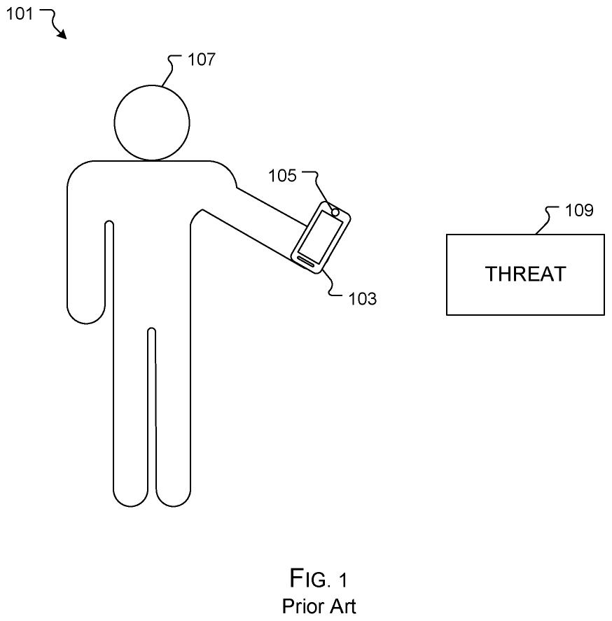

FIG. 2 is a diagram of a personal safety recording system in accordance with a preferred embodiment of the present application;

FIG. 3 is a cross-sectional side view of the body of FIG. 2

FIG. 4 is a flowchart of the preferred method of use of the system of FIG. 2;

FIGS. 5, 6 and 7 are front views of alternative embodiments of the body of FIG. 2;

FIG. 8 is a diagram of an alternative embodiment of the system of FIG. 2;

FIG. 9 is a list of contemplated embodiments of the activation device of FIG. 2; and

FIG. 10 is a cross-sectional side view of an alternative embodiment of the body of FIG. 2.

While the system and method of use of the present application is susceptible to various modifications and alternative forms, specific embodiments thereof have been shown by way of example in the drawings and are herein described in detail. It will be understood that the figures presented herein are not intended to be to scale but are given and sized to clarify the intent of the disclosure. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional portable security systems. Specifically, the invention of the present application provides for concealing while creating a recording and notifying others of an event. In addition, the invention enables rapid dissemination of video and location information regarding a presumed threat. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

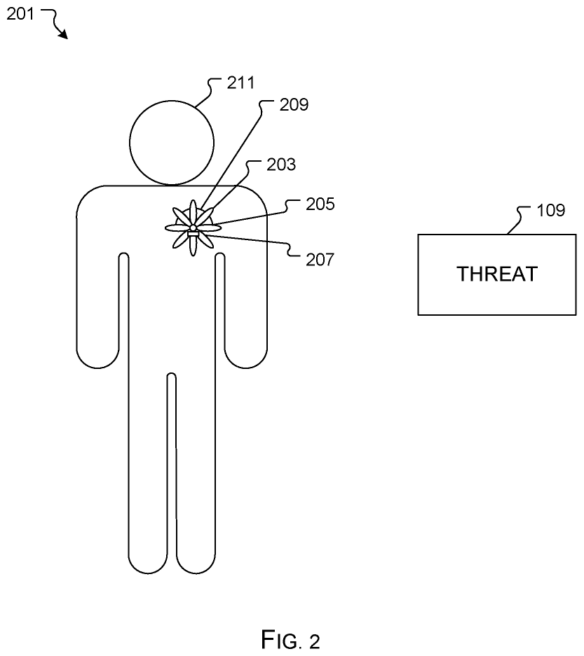

Referring now to the drawings wherein like reference characters identify corresponding or similar elements throughout the several views, FIG. 2 depicts a diagram of a personal safety recording system in accordance with a preferred embodiment of the present application. It will be appreciated that system 201 overcomes one or more of the above-listed problems commonly associated with conventional portable security systems.

In the contemplated embodiment, system 201 includes a body 203 that houses a recording device 205 therein. The recording device 205 has an activation device 207 in communication therewith. The body 203 has mounting device 209 attached to the back thereof that enables the body 203 to be secured to a person 211.

In use, the person 211 wears the body 203 with the recording device 205 when they move about. When a threat 109 is detected the activation device 207 initiates the recording device 205. The body 203 conceals the recording device 205 from the threat 109 to prevent removal, halting or destruction of the recording.

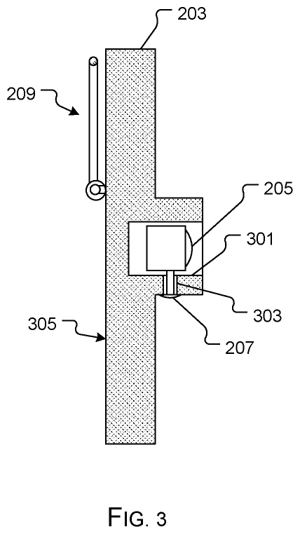

Referring now to FIG. 3 the body 203 is depicted for clarity. The body 203 includes a space 301 wherein the recording device 205 is housed. The activation device 207 having access to the recording device 205 via a passageway 303. The attachment device 209 is depicted as a clasp attached to the back surface 305 of the body. While the clasp is depicted any method of securing the body 203 to a person is contemplated.

It should be appreciated that one of the unique features believed characteristic of the present application is that body 203 increases the ability of the person 211 to obtain and retain a recording of threats 109.

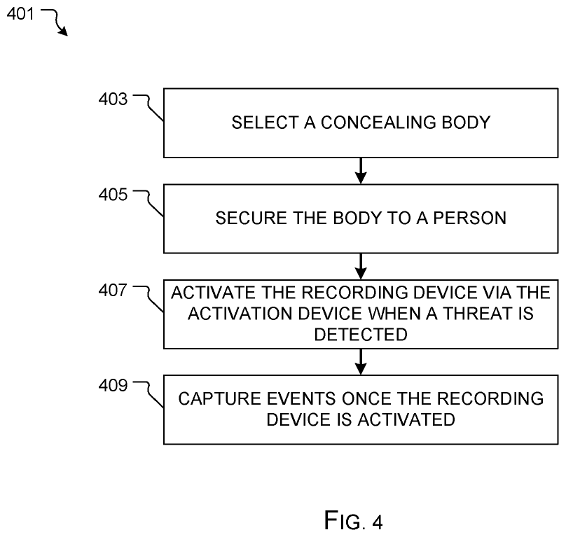

Referring now to FIG. 4 the preferred method of use of the system 201 is depicted. Method 401 includes selecting a concealing body 403, securing the body to a person 405, activating the recording device via the activation device when a threat is detected 407 and capturing events once the recording device is activated 409.

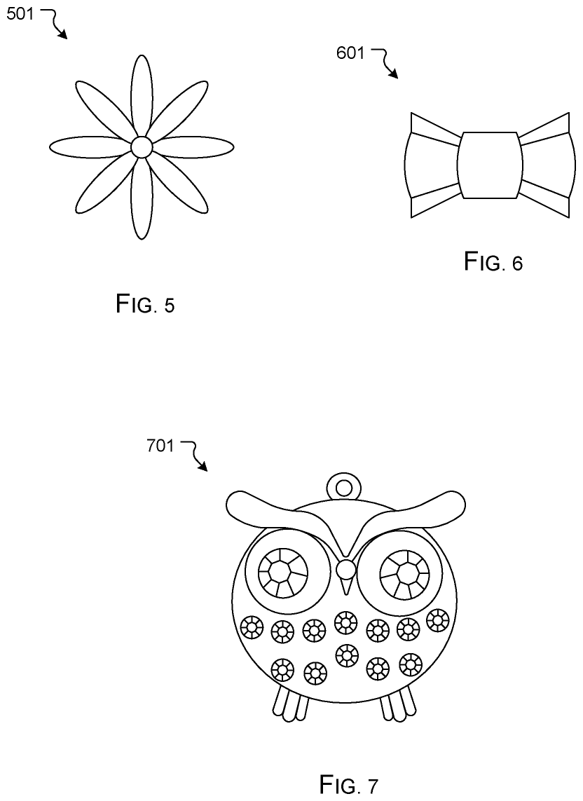

Referring now to FIGS. 5, 6 and 7 alternative embodiments of the body 203 are presented. Embodiments 501, 601 and 701 include a flower, bow, and owl respectively. The concept of the body to appear as an ordinary article that can house a recording device 205. The examples are given not to limit the idea.

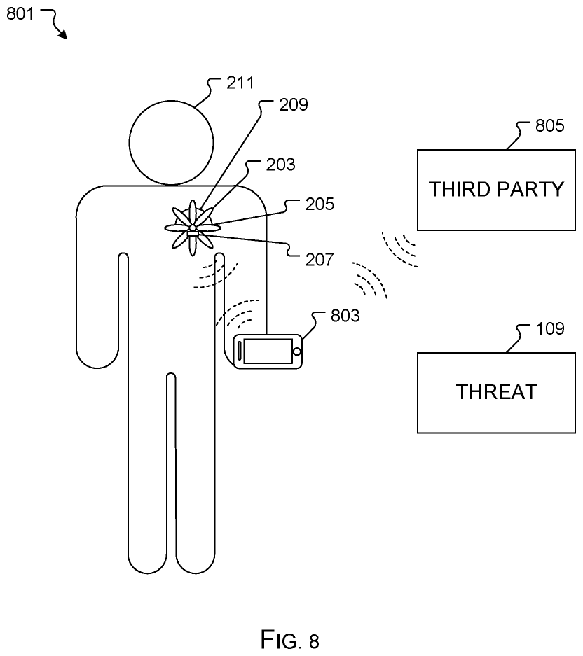

Alternatively, it is contemplated as depicted by FIG. 8, that the embodiment 801 could include a mobile device 803 in communication with the recording device 205. It is contemplated that the mobile device 803 would transmit the data from the mobile device 205, through a wireless server to a third party 805 after the device 207 is activated.

It will be appreciated that the mobile device 805 could have GPS, Bluetooth, wireless abilities. The transfer of the data from the recording device 205 would be automatic and not require activation or permission to transfer.

It is contemplated that the third party 805 could be friends, family or any other entity that could offer assistance or protection to the person 211.

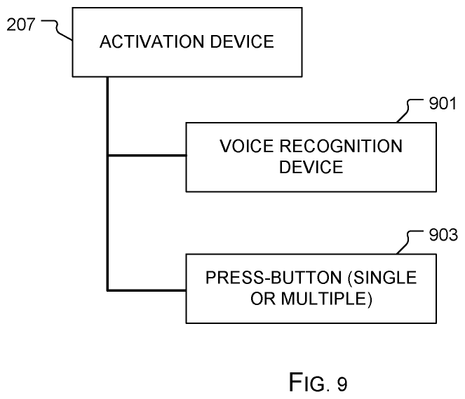

It will be understood and appreciated that the activation device 207 could consist of a voice recognition device 901 that detects vocal communication patterns, a press-button 903 or a combination of the two as depicted in FIG. 9. These embodiments of the activation device 207 are given as examples and not to limit the scope of possible methods of activation. Another benefit of the invention is that the voice commands captured by the voice recognition device 901 are more efficient as a result of being located in the body of the recording device 205 thereby increasing its accuracy and eliminating failed attempts to notify a third party 805 when desired by the person 211.

It will be appreciated that by having multiple buttons 903, such as a first and second button, that are required to be pressed at the same time reduces the unintentional activation of the system 201.

It will be appreciated that while the activation device 207 could initiate recording when a threat 109 is detected, initiate recording at any time the person 211 desires, notify a third party 801 of a threat 109 or event or be configured for any other action by the person 211.

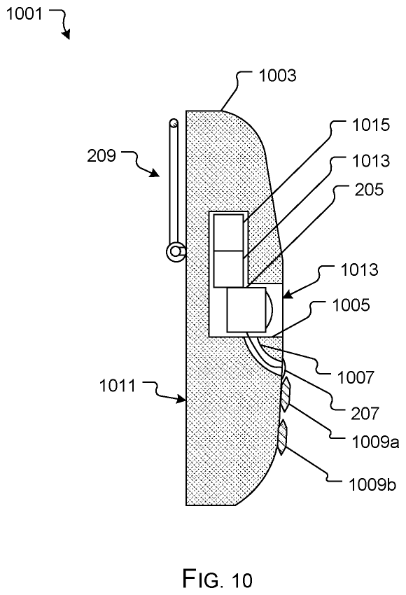

Referring now to FIG. 10 an alternative embodiment of the system is depicted. Embodiment 1001 includes a body 1003 housing the recording device 205 in space 1005 where the recording device is in communication with the activation device 207 via passageway 1007. The body 1003 having a mounting device 209 attached to the back surface 1011 thereof. An illumination device 1009 such as an infrared light emitting diode, is placed and attached over the opening of the space 1005 so that the recording device 205 is able to function better in low light conditions. It is contemplated that a jewel or replica could serve as the illumination device 1009 and further conceals that the embodiment 1001 contains a recording device 205.

It will be further appreciated that embodiment 1001 could also include a GPS locator 1013 and a transmitter 1015 in communication with the recording device 205 and are configured to directly transmit the data from the embodiment 1001 to a third party as described in embodiment 801.

It is contemplated that when the system 201 or any of the alternative embodiments 801 or 1001 are constantly recording the activation device could alert the system 201, that an event has or is about to occur. In embodiments 801 and 1001 that this includes the third party 805. It will be appreciated that this alert could indicate that a range of recorded data, either just before or after is transmitted or otherwise processed.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A personal safety recording system comprising:
a body configured to conceal at least one recording device therewithin;
at least one activation device in communication with the recording device; and
at least one attachment device configures to hold the body on a person;
wherein the activating device initiates the transfer of video, audio and location data.

2. The system of claim 1 wherein the body is shaped like an owl.

3. The system of claim 1 wherein the body is shaped like a flower.

4. The system of claim 1 wherein the recording device is in communication with a mobile device that transmits the data from the recording device to a third party.

5. The system of claim 3 wherein the location of the recording device is determined via GPS and the mobile device.

6. The system of claim 1 wherein an illumination device improves the ability of the recording device to function in low light conditions.

7. The system of claim 6 wherein the illumination device comprises an infrared light emitting diode.

8. The system of claim 1 wherein the activation device is a first and second button that are simultaneously pressed.

9. The method of capturing video as a security measure given the system of claim 1, comprising:
selecting a concealing body;
securing the body to a person;
activating the recording device via the activation device when a threat is detected; and
capturing events once the recording device is activated.
